(19) United States
(12) Patent Application Publication
(10) Pub. No.: US 2011/0244946 A1
(43) Pub. Date: Oct. 6, 2011

(54) PERSONALIZED GAMING EXPERIENCE

(75) Inventor: Gunjan Porwal, Pune (IN)

(73) Assignee: NVIDIA CORPORATION, Santa Clara, CA (US)

(21) Appl. No.: 12/753,906

(22) Filed: Apr. 5, 2010

(51) Int. Cl. A63F 9/24; G06F 17/30

(52) U.S. Cl. 463/23; 707/812; 707/706; 707/E17.005; 707/E17.014

(57) ABSTRACT

A method includes sensing data uniquely associated with a user of a gaming system through a sensor associated therewith and/or the gaming system. The method also includes intelligently personalizing a gaming experience of the user on the gaming system based on the sensed data.

### FIELD OF TECHNOLOGY

This disclosure relates generally to gaming systems and, more particularly, to personalization of a gaming experience of a user on a gaming system.

### BACKGROUND

Interacting with a gaming system (e.g., a gaming console, a computing system) may involve a user thereof personalizing parameters associated with a gaming experience including but not limited to a virtual representation (e.g., avatar) of the user, a game parameter (e.g., target points) and a display attribute (e.g., background color). For example, the virtual representation in the gaming environment may be a “realistic” manifestation of the user. The aforementioned parameters associated with the gaming experience may influence the satisfaction of the user and/or may affect the interactions of the user in, for example, a networked gaming environment including other users.

During the course of the gaming experience, the user may be provided options to choose from a number of possible parameters. Because of the possible vastness of the number of parameters, the user may have to navigate a number of menus/options and/or type in numerals/text as input to the gaming system to effect the personalization. The lack of user-friendliness in the personalization process and the tedium involved therein may cause the user to lose interest, despite his/her want of a personalized gaming experience. In a networked gaming environment, the loss of interest on part of the user and, hence, the non-personalization of the gaming environment thereof may frustrate interactions and/or emotional and social understanding between the user and other user(s) of the networked gaming environment.

### SUMMARY

Disclosed are a method, an apparatus and/or a system of personalizing a gaming experience of a user on a gaming system.

In one aspect, a method includes sensing data uniquely associated with a user of a gaming system through at least a sensor associated therewith and/or the gaming system. The method also includes intelligently personalizing a gaming experience of the user on the gaming system based on the sensed data.

In another aspect, a gaming system includes an interface configured to be coupled to an external sensor and/or an internal sensor configured to enable sensing of a data uniquely associated with a user of the gaming system. The gaming system also includes a memory configured to store the sensed data and a processor configured to effect an intelligent personalization of a gaming experience of the user based on the sensed data. The memory includes storage locations configured to be addressable by the processor.

In yet another aspect, a medium, readable through a gaming system and including instructions embodied therein that are executable on the gaming system, includes instructions associated with sensing data uniquely associated with a user of the gaming system through a sensor associated therewith and/or the gaming system. The medium also includes instructions associated with intelligently personalizing a gaming experience of the user on the gaming system based on the sensed data.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a gaming system, according to one or more embodiments.

FIG. 2 is a schematic view of a gaming console exemplifying the gaming system of FIG. 1, according to one or more embodiments.

FIG. 3 is a schematic view of the gaming console of FIG. 2 including a virtual representation of a user thereof displayed therein, according to one or more embodiments.

FIG. 4 is a schematic view of the gaming console of FIG. 2 including a personalized virtual representation of the user thereof displayed therein, according to one or more embodiments.

FIG. 5 is a schematic view of an example personalization of a gaming experience of the user of the gaming console of FIG. 2 through the utilization of an audio sensor, according to one or more embodiments.

FIG. 6 is a process flow diagram detailing the operations involved in a method of personalizing a gaming experience of a user on a gaming system, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of personalizing a gaming experience of a user on a gaming system. Although the present embodiments have been described with reference to specific example embodiments, it will be evident that various modifications and changes may be made to these embodiments without departing from the broader spirit and scope of the various embodiments.

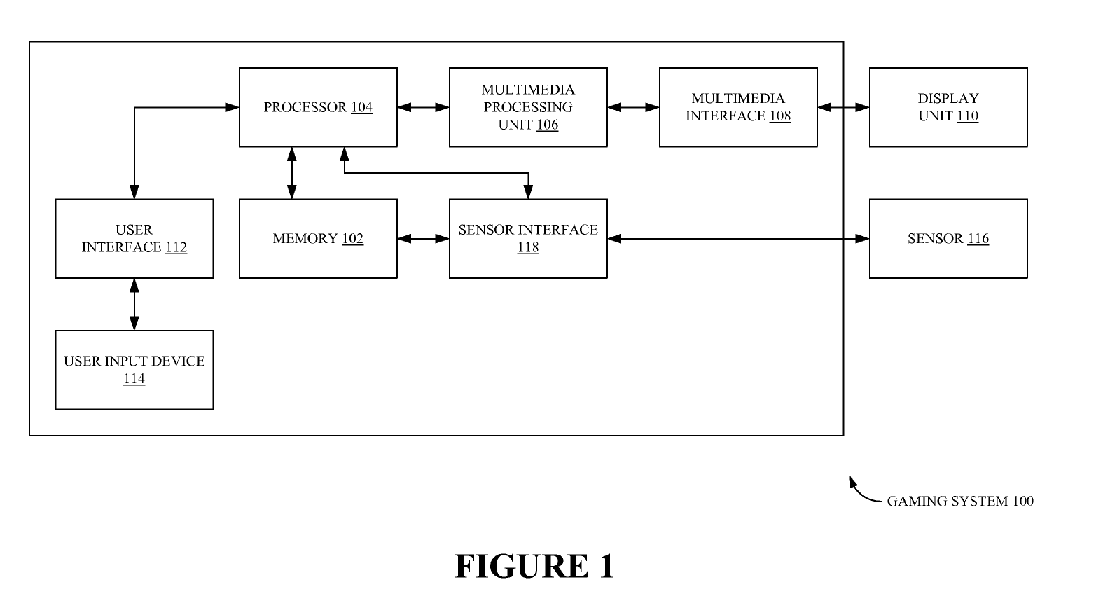

FIG. 1 shows a gaming system 100, according to one or more embodiments. In one or more embodiments, gaming system 100 may include a computing system (e.g., a desktop computer, laptop computer, notebook computer) or a gaming console, on which a user may execute/play games available on media such as Compact Discs (CDs), Digital Video Discs (DVDs), Blu-Ray™ discs and gaming cartridges, or on downloaded files stored in a memory 102 (e.g., hard drive) of gaming system 100. In one or more embodiments, the user may access remotely hosted games through a network (e.g. Internet). Examples of gaming consoles include but are not limited to Nintendo GameCube®, Nintendo®'s Gameboy® Advance, Sony®'s PlayStation™ console®, Nintendo®'s Wii™, and Microsoft®'s Xbox 360®.

In one or more embodiments, memory 102 of gaming system 100 may include a volatile memory (e.g., Random Access Memory (RAM)) and/or a non-volatile memory (e.g., Read-Only Memory (ROM), hard disk). In one or more embodiments, at least some portion of memory 102 (e.g., ROM) may be part of a processor 104 of gaming system 100. In one or more embodiments, processor 104 may include a Central Processing Unit (CPU) and/or a Graphics Processing Unit (GPU). In one or more embodiments, memory 102 may be separate from processor 104. In one or more embodiments, the GPU may be configured to perform intensive graphics processing. In one or more embodiments, two or more GPUs may be provided in gaming system 100 to perform the abovementioned graphics processing. In one or more embodiments, memory 102 may include storage locations configured to be addressable by processor 104. In one or more embodiments, when gaming system 100 is powered ON (e.g., by powering ON gaming console, by powering ON computing system), instructions associated with loading an operating system therein (e.g., resident in a hard disk associated with memory 102) stored in memory 102 (e.g., non-volatile memory) may be executed through processor 104.

In one or more embodiments, output data associated with processing through processor 104 may be input to a multimedia processing unit 106 configured to perform encoding/decoding associated with the data. In one or more embodiments, the output of multimedia processing unit 106 may be rendered on a display unit 110 through a multimedia interface 108 configured to convert data to an appropriate format required by display unit 110. In one or more embodiments, display unit 110 may be a computer monitor/display (e.g., Liquid Crystal Display (LCD) monitor, Cathode Ray Tube (CRT) monitor) associated with gaming system 100. In one or more embodiments, display unit 110 may also be a monitor/display embedded in the gaming console. In one or more embodiments, a user interface 112 interfaced with processor 104 may be provided in gaming system 100 to enable coupling of a user input device 114 to processor 104 there through. In one or more embodiments, user input device 114 may include a keyboard/keypad and/or a pointing device (e.g., mouse, touch pad, trackball). In one or more embodiments, user input device 114 may also include a joystick or a gamepad.

In one or more embodiments, user interface 112 may be coupled to the system bus configured to couple other constituent elements of gaming system 100. In one or more embodiments, user interface 112 may be a game port or a Universal Serial Bus (USB) port configured to couple user input device 114 to processor 104. In one or more embodiments, gaming system 100 may include a sensor 116 configured to sense data uniquely associated with a user of gaming system 100. In one or more embodiments, sensor 116 may be configured to be coupled to processor 104 and/or memory 102 through a sensor interface 118. In one or more embodiments, sensor 116 may be analogous to user input device 114, but may be configured to sense data uniquely associated with the user with/without the knowledge of the user. In one or more embodiments, sensor interface 118 may be analogous to user interface 112. In one or more embodiments, sensor 116 may either be an external sensor (e.g., not part of gaming system 100) or an internal sensor available along with gaming system 100. In one or more embodiments, sensor 116 may be part of the gaming console/computing system. In one or more embodiments, in case of external sensors, an appropriate sensor interface may be provided in gaming system 100 to enable coupling of gaming system 100 to the external sensors.

Examples of sensor 116 may include but are not limited to an audio sensor (e.g., audio recorder, voice sensor, microphone), a video sensor (e.g., video camera, digital camcorder) and an image sensor (e.g., digital camera). In one or more embodiments, data sensed through sensor 116 may be utilized to obtain information about a user preference (e.g., preferred brand of mobile phone, preferred pizza outlet) and/or a behavioral pattern (e.g., walking style, body language) of the user of gaming system 100. In one or more embodiments, information about the user preference and/or behavioral pattern may be obtained based on analyzing data sensed through sensor 116.

In one or more embodiments, a virtual representation (e.g., avatar) of the user may contribute to personalization of the gaming experience of the user. In one or more embodiments, other users of a networked gaming environment in which the user of gaming system 100 is also a participant may interact (e.g., remotely) with the user based on the virtual representation thereof. In one or more embodiments, in a non-networked gaming environment, data associated with the virtual representation of the user and/or the virtual representation of the user may be stored in a database associated with memory 102. For example, the aforementioned database may be available as file(s) in a folder of a hard drive of a computing system used for gaming. The database of possible virtual representations including data/attributes associated therewith may be available on a commercial game media disc. The user may install the game in a non-volatile memory (e.g., hard disk) associated with gaming system 100, thereby enabling availability of the database therein.

The user may also execute the game from the drive associated with the game media disc in gaming system 100. In another example, the aforementioned database may be compressed in a file associated with the game downloaded to the non-volatile memory (e.g., hard disk), where the file includes the database of possible virtual representations. The user may extract the contents of the downloaded file to an appropriate folder of a hard drive of a computing system (or, to an appropriate location in storage associated with a gaming console) or install the game therein using the downloaded file.

In one or more embodiments, the user may choose a virtual representation from a number of virtual representations available in the database. In one or more embodiments, the user may also choose components associated with the number of virtual representations to enable realization of a desired virtual representation. For example, the user may choose a hat from a number of possible hats, a shoe from a number of possible shoes, a skin color from a number of possible skin colors, a shirt from a number of possible shirts etc. The aforementioned individual preferences may contribute to the personalization of the gaming experience of the user.

In one or more embodiments, in a networked gaming environment, the database of possible virtual representations and/or data/attributes associated therewith may be remotely located on a host server. In one or more embodiments, the virtual representation chosen by the user and/or data/attributes associated therewith may be locally stored in a database associated with memory 102 of gaming system 100. In one or more embodiments, this locally stored database may serve as a profile of the user. It is obvious that this profile of the user may also be available on the database associated with memory 102 in a non-networked gaming environment. In one or more embodiments, if the user modifies his/her virtual representation, the profile may be appropriately updated through a communication from processor 104.

With regard to an example sensing through sensor 116 discussed above, a microphone provided in gaming system 100 may capture voice data of the user of gaming system 100 with/without his/her knowledge during the course of the gaming experience. The voice data may be utilized to identify the accent of the user based on stresses on words and other peculiarities therein. Processor 104 may be utilized in the aforementioned analysis, following which the profile of the user may be appropriately updated to effect a change in the accent of the virtual representation of the user. For example, if the user speaks English with a German accent, the data associated with the virtual representation may be intelligently updated to reflect the German accent. This may further personalize the gaming experience of the user and/or render the virtual representation more realistic. The “closer to reality” aspect may provide an accurate cultural/behavioral reflection of the user to other users of a networked gaming environment in which the user is a participant.

In another example, the user may be a native Spanish speaker. The voice data captured (e.g., a communication between the user and a friend in the same location as gaming system 100) by a microphone (i.e., an example of sensor 116) provided in gaming system 100 during the gaming experience of the user may be analyzed to effect a change in the gaming environment such that the text/audio content therein is in Spanish. In yet another example, the user may communicate a green background color preference to the friend at the location of gaming system 100. Based on this, the background color of the gaming environment may then be modified from the current color to green automatically during the gaming experience. Alternately, the sensed data may be stored and the changes effected following the reboot of gaming system 100.

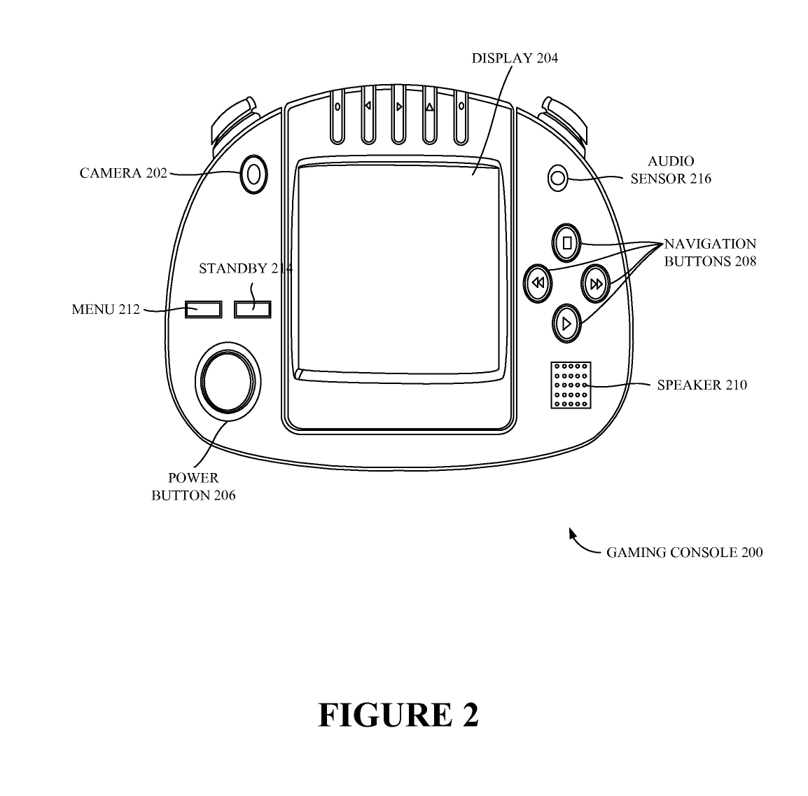

FIG. 2 shows an example gaming console 200 in a powered OFF mode, according to one or more embodiments. The gaming console 200, exemplifying gaming system 100, may include a camera 202 as an example sensor 116 configured to capture an image/video of the user during both an active mode of operation and/or a passive mode of operation thereof. In one or more embodiments, active mode of gaming console 200 may be defined as a mode of operation during which a user of gaming console 200 is active with regard to gaming therein. In FIG. 2, the active mode may be a mode of operation where gaming console 200 is powered ON (e.g., by pressing power button 206) and the user is actively gaming (e.g., utilizing navigation buttons 208 on gaming console 200) therein. In one or more embodiments, the passive mode of gaming console 200 may be defined as a mode of operation during which the user of gaming console 200 is inactive with regard to gaming therein. In FIG. 2, the passive mode may be a mode of operation where gaming console 200 is switched ON and the user is inactive with regard to gaming therein. In both the active mode and the passive mode of operation of gaming console 200, camera 202 (i.e., an example sensor 116) may be turned ON.

In case of the user not utilizing navigation buttons 208 for a time period exceeding a threshold, the processor (e.g., processor 104) may cause display 204 of gaming console 200 to go into a “power save” mode. The “power save” mode may be analogous to the user pressing standby 214 button on gaming console 200, and may be interpreted as a passive mode of operation thereof. In an example embodiment, in case of the user being active with regard to gaming on gaming console 200 but not utilizing navigation buttons 208 for the time period exceeding the threshold, the locational proximity of the user to gaming console 200 may be utilized to maintain the active mode of operation. Here, the locational proximity may be determined based on data captured through camera 202 and/or another appropriate sensor (e.g., position sensor).

As shown in FIG. 2, gaming console 200 may include a menu 212 button configured to enable the user to view/choose options (e.g., pause game, restart game, quit game) with regard to a game rendered on display 204. Gaming console 200 may also include a speaker 210 configured to enable rendering of audio associated with the game therein. In the abovementioned example of accent analysis of the user, the personalized accent of the virtual representation of the user may be heard by the user through speaker 210.

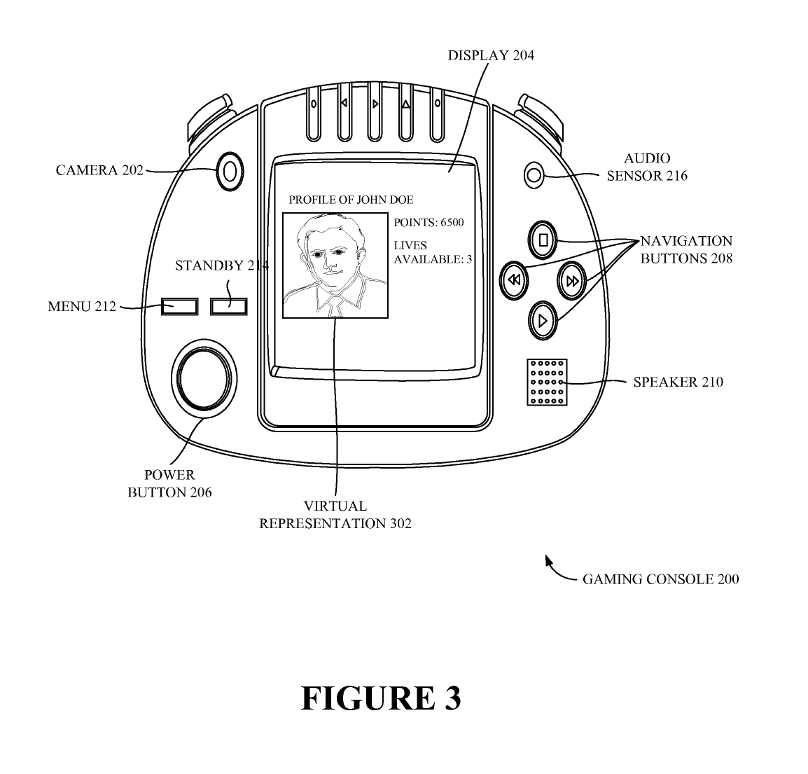

FIG. 3 shows a virtual representation 302 of a user of gaming console 200 in a gaming environment thereof, according to one or more embodiments. The user of gaming console 200 may have chosen the profile image shown in display 204 along with game statistics (e.g., points, lives available) associated therewith from a number of available profile images to serve as his/her “realistic” virtual representation 302. The vastness of the available options may have made it impossible for the user to exactly represent himself/herself virtually in an accurate manner. For example, the user may use eyeglasses on a daily basis but may have forgotten to incorporate the detail in his/her virtual representation.

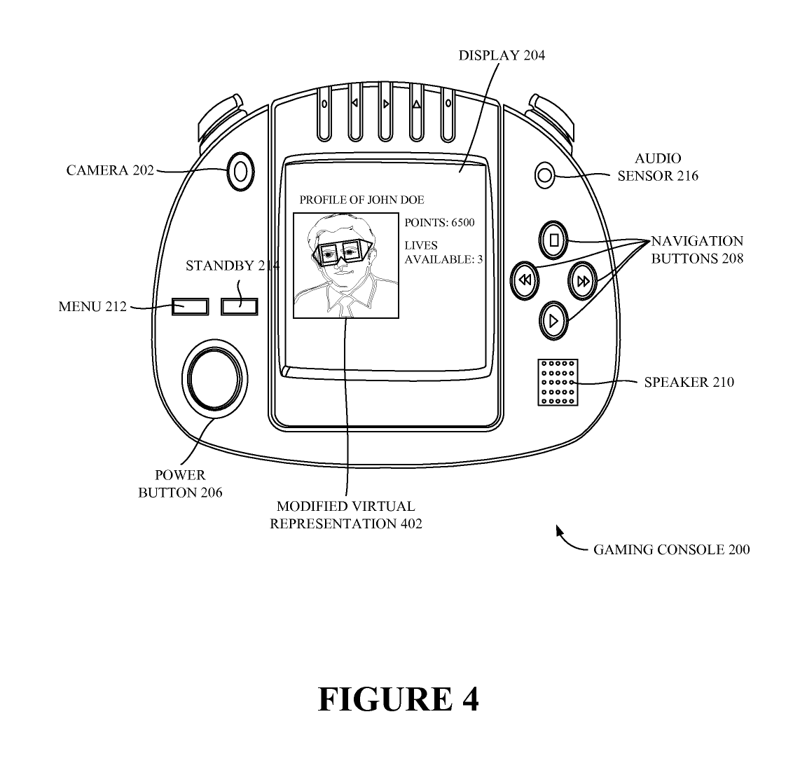

FIG. 4 shows a personalized virtual representation 402 of the user of gaming console 200 in the gaming environment, according to one or more embodiments. Camera 202 may be configured through a processor (e.g., processor 104) of gaming console 200 to capture an image/video of the user in the active mode and/or the passive mode of operation of gaming console 200. In an example embodiment, camera 202 may capture the image/video of the user periodically. Data associated with the image/video may be transmitted from camera 202 to the processor (e.g., processor 104), following which the determination that the user is spectacled is done. The aforementioned determination may be done based on, for example, an image processing algorithm implemented through the processor (e.g., processor 104). In one or more embodiments, instructions associated with the image processing algorithm may be stored in a memory (e.g., memory 102) of gaming console 200.

Once the determination that the user is spectacled is done, virtual representation 302 may be appropriately modified to personalized virtual representation 402 through the processor (e.g., processor 104) to reflect the eyeglasses of the user, as shown in FIG. 4. In one example embodiment, the user may be prompted to accept/decline the modification, and virtual representation 302 may only be appropriately modified after the acceptance from the user. In one or more embodiments, a database, associated with the memory (e.g., memory 102) of gaming console 200 and including the profile of the user, may also be appropriately modified through the processor (e.g., processor 104). Thus, the virtual representation of the user may be personalized intelligently through gaming console 200. In one or more embodiments, a new virtual representation and/or a component (e.g., eyeglasses) of a virtual representation may be created through the utilization of graphics processing in the processor (e.g., processor 104) of gaming console 200 based on the sensed data uniquely associated with the user. In one or more embodiments, the new virtual representation and/or the associated data therewith may, again, be stored in the database, associated with the memory (e.g., memory 102) of gaming console 200 and including the profile of the user.

In case of a networked environment, the user may also be able to store the new virtual representation and/or the associated data therewith in a database remotely located in a host server. The user may also have the option to make the new virtual representation and/or data associated therewith “public,” i.e., available to and utilizable by users of the networked environment.

Other examples of personalization of the virtual representation include personalizing the walking style of the virtual representation based on video sensing the walking style of the user and personalizing the laughing style associated with the virtual representation based on recorded audio associated with the user. The utility of sensing user data is not limited to the aforementioned examples.

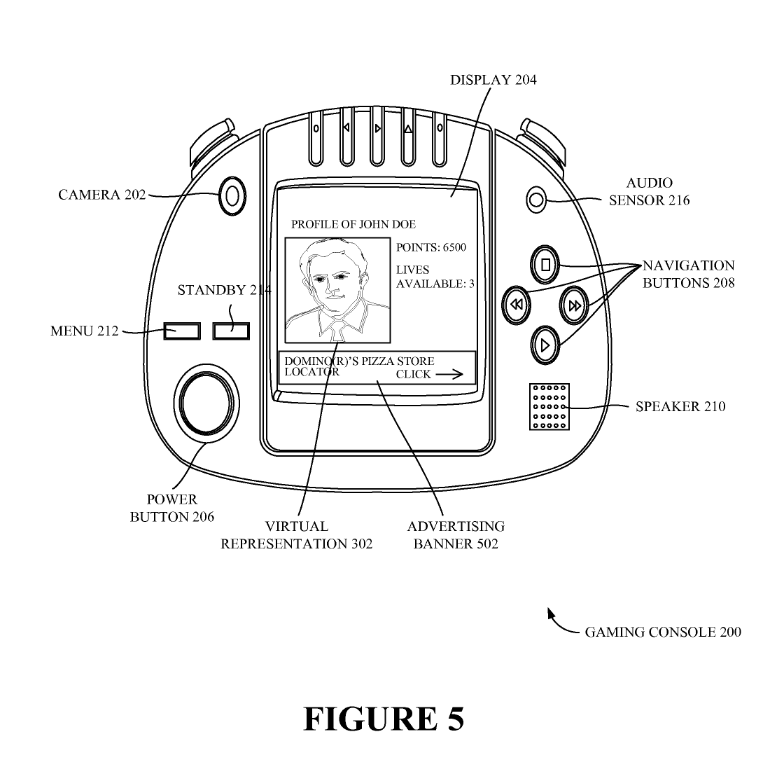

As shown in FIGS. 2-4, gaming console 200 may also have an audio sensor 216 (e.g. microphone) configured to monitor audio uniquely associated with the user. FIG. 5 shows an example personalization of a gaming experience of a user of gaming console 200 through the utilization of audio sensor 216, according to one or more embodiments. With regard to FIG. 5, the user may communicate to a friend at the location of gaming console 200 that he/she desires to order Domino's pizza® while gaming therein but does not know the requisite contact details to place a phone/Internet order. Audio sensor 216 may capture the conversation during the active and/or passive mode, and transmit data associated therewith to the processor (e.g., processor 104). With the help of, for example, a speech recognition algorithm implemented through the processor (e.g., processor 104), gaming console 200 may recognize the “desire” of the user. Here, instructions associated with the speech recognition algorithm may be stored in the memory (e.g., memory 102) of gaming console 200.

The processor (e.g., processor 104) may then interact with the operating system therein to open a web browser (e.g., Microsoft®'s Internet Explorer®), through a which, for example, information associated with an appropriate advertising banner 502 displaying “Domino®'s store locator” and a web link therefor may be obtained using a third party search engine (e.g., Google®). The advertising banner 502 may then be embedded in the gaming environment after the processor (e.g., processor 104) updates a database associated with the memory (e.g., memory 102) that includes information associated with the user. Alternately, a current advertising banner shown during the gaming experience of the user may be modified to the Domino®'s banner. In one or more embodiments, the aforementioned processes may occur in the background during the gaming experience of the user.

In one or more embodiments, a database of popular advertising banners/links may be available as a file on a commercial game media disc. In one or more embodiments, the user may download a game file and extract the contents therein including the database to gaming console 200. In one or more embodiments, the database may be downloaded from a remotely located host server. In one embodiment, with regard to FIG. 5, the web browser may be opened to search in a third party database (e.g., phone directory), through which the contact details of an appropriate Domino®'s store may be obtained. The phone number may be made available to the user during the course of the gaming experience on, for example, a newly created banner.

Again with regard to FIG. 5, the friend of the user may prefer pizza from Pizza Hut® to Domino®'s. When the friend of the user utilizes gaming console 200 for gaming, a banner relating to Pizza Hut® may be displayed instead of Domino®'s, as in the case of the user. Thus, in one or more embodiments, based on the sensed data uniquely associated with a user of gaming console 200, the gaming experience may be dynamically personalized.

One skilled in the art will appreciate that the utility of sensing data uniquely associated with the user of gaming system 100 is not limited to personalizing a virtual representation, providing personalized advertising banners and/or personalizing background colors. Other scenarios involving personalization of the gaming experience include but are not limited to personalizing display attributes associated with the gaming experience such as resolution and screen size, and automatically setting targets (e.g., target points) in games. In another example scenario, the user may be playing a shooting game, where the number of lives he/she is left with has dwindled to a minimum. Based on, for example, sensed audio data of the user, the warning associated with the minimum remaining lives may be personalized (e.g., by increasing volume of an alarm indicating the warning).

In one or more embodiments, sensing data uniquely associated with the user is not limited to sensing audio data, video data and/or image data. In one example embodiment, the user may chat (e.g., through Instant Messaging (IM)) with another user in a networked gaming environment during the course of a game. In one or more embodiments, the keystrokes of the user, for example, may be monitored (e.g., sensed), based on which the gaming experience of the user may be personalized. Thus, text monitoring/sensing through gaming system 100 is within the scope of the exemplary embodiments. A sensor 116, as understood in the traditional sense, may not be needed in the aforementioned scenario. In one or more embodiments, a combination of personalizations may be effected based on the sensed data. In one example embodiment, both a visual feature and an audio feature associated with the virtual representation of the user may be personalized. In another example embodiment, the virtual representation and a display attribute may be personalized. In one or more embodiments, a number of sensors 116 may operate in parallel to obtain data uniquely associated with the user.

In one or more embodiments, the gaming discussed herein is not limited to games understood in the traditional sense. In one or more embodiments, virtual worlds (e.g., Second Life®) may also be construed as games. In one example embodiment, during the course of the gaming experience, the user may choose to interact with other users through an online forum associated with the game. The profile of the user in the forum may include a virtual representation as, for example, an image, which may be the same virtual representation image dynamically and intelligently personalized during the gaming experience. Such game-related online forum interactions are within the scope of the exemplary embodiments.

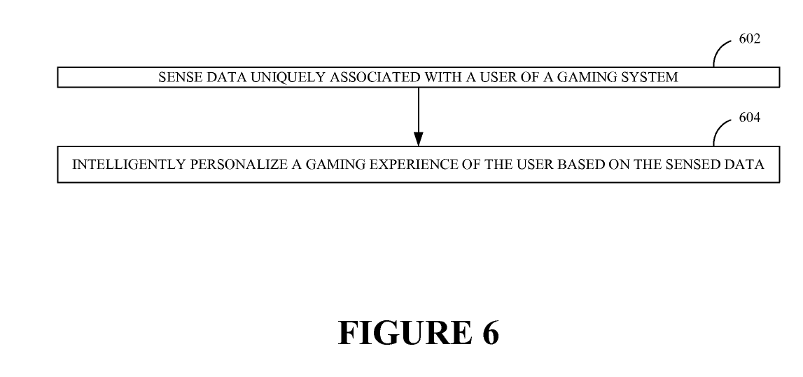

FIG. 6 shows a process flow diagram detailing the operations involved in a method of personalizing a gaming experience of a user on a gaming system, according to one or more embodiments. In one or more embodiments, operation 602 may involve sensing a data uniquely associated with the user of the gaming system through a sensor associated therewith and the gaming system. In one or more embodiments, operation 604 may then involve intelligently personalizing the gaming experience of the user on the gaming system based on the sensed data.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device), and may be performed in any order (e.g., including using means for achieving the various operations). Various operations discussed above may be tangibly embodied on a medium readable through gaming system 100 to perform functions through operations on input and generation of output. These input and output operations may be performed by a processor (e.g., processor 104). The medium readable through gaming system 100 may be, for example, a memory, a transportable medium such as a CD, a DVD, a Blu-ray™ disc, a floppy disk, or a diskette. The medium may include instructions embodied therein that are executable on gaming system 100. A computer program embodying the aspects of the exemplary embodiments may be loaded onto gaming system 100. The computer program is not limited to specific embodiments discussed above, and may, for example, be implemented in an operating system, an application program, a foreground or background process, a driver, a network stack or any combination thereof. For example, software associated with sensor 116 may be available on the medium readable through gaming system 100. The computer program may be executed on a single computer processor or multiple computer processors.

Accordingly, the specification and drawings are to be regarded in an illustrative rather than a restrictive sense.

What is claimed is:

1. A method comprising:
sensing data uniquely associated with a user of a gaming system through at least one of a sensor associated therewith and the gaming system; and
intelligently personalizing, on the gaming system, a gaming experience of the user based on the sensed data.

2. The method of claim 1, comprising intelligently personalizing the gaming experience of the user during at least one of an active mode of operation and a passive mode of operation of the gaming system,
wherein the user is active with regard to gaming on the gaming system during the active mode of operation,
wherein the user is inactive with regard to gaming on the gaming system during the passive mode of operation, and
wherein the sensor of the gaming system is configured to sense the data uniquely associated with the user during both the passive mode of operation and the active mode of operation.

3. The method of claim 1, comprising sensing at least one of an image data associated with the user, an audio data associated with the user, a video data associated with the user, and a text data associated with the user.

4. The method of claim 1, comprising intelligently personalizing at least one of a virtual representation of the user associated with at least one of the gaming experience thereof and a virtual interaction associated with the gaming experience, a display attribute of the gaming system, an in-game advertising, and a game parameter.

5. The method of claim 1, wherein intelligently personalizing the gaming experience of the user comprises:
analyzing the sensed data through at least one of a processor and a memory of the gaming system to obtain requisite information associated with the intelligent personalization; and
modifying the gaming experience of the user to reflect the obtained requisite information therein.

6. The method of claim 3, further comprising determining at least one of a user preference and a user behavioral pattern based on the sensed at least one of the image data, the audio data, the video data, and the text data.

7. The method of claim 5, further comprising:
storing data associated with the user in a database associated with the memory of the gaming system; and
updating the database through the processor to reflect the intelligent personalization of the gaming experience of the user based on the sensed data uniquely associated with the user.

8. The method of claim 5, wherein analyzing the sensed data comprises:
leveraging at least one of a third party database and a third party search engine based on the sensed data; and
obtaining a data of interest to the user as the requisite information based on the leverage.

9. A gaming system comprising:
at least one of an interface configured to be coupled to an external sensor and an internal sensor configured to enable sensing of a data uniquely associated with a user of the gaming system;
a memory configured to store the sensed data; and
a processor configured to effect an intelligent personalization of a gaming experience of the user based on the sensed data,
wherein the memory includes storage locations configured to be addressable by the processor.

10. The gaming system of claim 9, wherein the processor is configured to effect the intelligent personalization of the gaming experience of the user during at least one of an active mode of operation and a passive mode of operation of the gaming system,
wherein the user is active with regard to gaming on the gaming system during the active mode of operation,
wherein the user is inactive with regard to gaming on the gaming system during the passive mode of operation, and
wherein at least one of the external sensor and the internal sensor of the gaming system is configured to sense the data uniquely associated with the user during both the passive mode of operation and the active mode of operation.

11. The gaming system of claim 9, wherein at least one of the external sensor and the internal sensor of the gaming system is configured to sense at least one of an image data associated with the user, an audio data associated with the user, a video data associated with the user, and a text data associated with the user.

12. The gaming system of claim 9, wherein the processor is configured to effect the intelligent personalization of at least one of a virtual representation of the user associated with at least one of the gaming experience thereof and a virtual interaction associated with the gaming experience, a display attribute of the gaming system, an in-game advertising, and a game parameter.

13. The gaming system of claim 9,
wherein at least one of the processor and the memory is configured to analyze the sensed data to obtain requisite information associated with the intelligent personalization, and
wherein the gaming experience of the user is modified to reflect the obtained requisite information therein.

14. The gaming system of claim 9, wherein the memory includes at least one of a non-volatile memory and a volatile memory.

15. The gaming system of claim 9, wherein the processor includes at least one of a Central Processing Unit (CPU) and a Graphics Processing Unit (GPU).

16. The gaming system of claim 9, wherein the memory and the processor are associated with at least one of a computing system and a gaming console.

17. The gaming system of claim 13,
wherein data associated with the user is configured to be stored in a database associated with the memory, and
wherein the processor is configured to update the database to reflect the intelligent personalization of the gaming experience of the user based on the sensed data uniquely associated with the user.

18. The method of claim 13, wherein at least one of a third party database and a third party search engine is leveraged based on the sensed data to obtain the requisite information.

19. A medium, readable through a gaming system and including instructions embodied therein that are executable on the gaming system, comprising:
instructions associated with sensing data uniquely associated with a user of the gaming system through at least one of a sensor associated therewith and the gaming system; and
instructions associated with intelligently personalizing a gaming experience of the user on the gaming system based on the sensed data.

20. The medium of claim 19, wherein the medium is one of a memory, a Compact Disc (CD), a Digital Video Disc (DVD), a Blu-ray™ disc, a floppy disk and a diskette.
